(19) United States
(12) Patent Application Publication
(10) Pub. No.: US 2006/0053413 A1
(43) Pub. Date: Mar. 9, 2006

(54) Debug system for debugging multi-task system

(76) Inventors: Shinichi Kimura, Osaka-shi (JP); Yoshikazu Yamamoto, Osaka-shi (JP); Motoshi Ito, Osaka-shi (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/220,090

(22) Filed: Sep. 6, 2005

(30) Foreign Application Priority Data
Sep. 6, 2004 (JP) 2004-258675

(51) Int. Cl. G06F 9/44

(52) U.S. Cl. 717/124

(57) ABSTRACT

A debug system and method for facilitating debug of a multi-task system, and a circuit and the like capable of adopting such a debug method are provided. The debug system of the present invention includes: a host computer for executing a debugger program; and a circuit having a complex system constructed thereon including a first multi-task system to be debugged by the debugger program and a second multi-task system which is not a target of debug. The circuit includes a memory having a program stored thereon, and a processor capable of executing the program on the memory. The memory has a first operating system for managing at least one task program in the first multi-task system; and a second operating system for managing the first operating system as a first task program and managing at least one second task program different from the first task program.

### BACKGROUND OF THE INVENTION

1. Field of the Invention

The present invention relates to a debug system and a debug method for debugging a multi-task system. More particularly, the present invention relates to a debug method for debugging a program of a multi-task system including a plurality of task processes and an interruption process, and a system, a circuit and the like capable of debugging the task program using the debug method.

2. Description of the Related Art

In conventional computer systems, a single-task program for managing one job as one task is processed on one processor. Recently, however, various types of multi-task systems for processing a multi-task program including a plurality of independent tasks on one processor have been developed. With a multi-task program, a plurality of tasks can be apparently executed on a computer simultaneously (in parallel), and thus the work efficiency can be improved.

As an example of computer systems, optical disc systems which use an optical disc to record and/or reproduce information are known. FIG. 20 shows a schematic structure of a conventional optical disc system. The optical disc system includes a drive device 91 capable of having an optical disc 8 mounted thereon and a host computer 92. The drive device 91 and the host computer 92 are connected to each other via a host interface bus 93.

The optical disc system includes a system controller 94 and an optical disc controller 95. The system controller 94 and the optical disc controller 95 are each implemented as an independent LSI and each function as a separate multi-task system.

The system controller 94 controls the overall operation of the drive device 91 in accordance with a built-in host control task 1711 and a built-in drive control task 1722. For example, a CPU 96 of the system controller 94 processes the host control task 1711 and the drive control task 1722 which are managed by a first operating system (“first OS”).

The optical disc controller 95 controls accesses for information recording to and information reproduction from the optical disc 8 in accordance with respective tasks. For example, a CPU 97 of the optical disc controller 95 processes a servo control task 1721 and a disc control task 1722 which are managed by a second operating system “second OS”.

The tasks of the system controller 94 and the optical disc controller 95 operate the drive device 91 in cooperation with one another.

For example, the drive control task 1712 of the system controller 94 issues a data read request or a data write request to the disc control task 1722 of the optical disc controller 95. Then, the disc control task 1722 executes the data read or the data write. The read data or a notice indicating whether the data write has been completed or failed is sent back to the drive control task 1712.

Along with the development of multi-task programs, various technologies for debugging a multi-task program have been developed. For example, Japanese Laid-Open Patent Publication No. 2-300942 discloses a debug method. According to this debug method, a plurality of tasks are designated from tasks operating on an operating system (hereinafter, referred to also as an “OS”). When the execution of any one of the designated tasks is suspended by, for example, a break point, the execution of the other designated tasks, which are targets of debug, are also suspended.

Japanese Laid-Open Patent Publication No. 4-314141 discloses a multi-task control method for debugging. According to this multi-task control method, when an arbitrary task included in a multi-task job reaches a preset break point, or when an exception occurs, the execution of all the tasks belonging to the multi-task job group of that task is suspended. With this multi-task control method, the execution of all the tasks in the multi-task job group can be resumed at any time.

A computer system including a plurality of independent multi-task systems as shown in FIG. 20 generates the following two problems when a specific multi-task system is debugged using a conventional debug method.

A first problem is that it becomes necessary to develop a first OS and a second OS respectively relying on the hardware of the system controller 94 and the hardware of the optical disc controller 95, and also to create a task program to be executed on each of the first OS and the second OS. This significantly increases the costs for the components of the LSI used as each controller and also the costs for developing the operating systems and the tasks.

A second problem is that with a conventional multi-task system debug method, an interruption processing program and the like cannot be debugged. The reason is that the conventional debug method realizes the debugging function on a task level. More specifically, an interruption processing program is not managed as a task and exists as an independent processing program. Since the interruption program cannot be debugged in a similar manner to the tasks for this reason, the entire multi-task system including the interruption process cannot be debugged. In order to allow an interruption request to be accepted from another controller, an environment for debugging the interruption process needs to be prepared.

### SUMMARY OF THE INVENTION

In order to overcome the problems described above, preferred embodiments of the present invention provide a debug system and a debug method for facilitating debug of a multi-task system, and a circuit and the like capable of adopting such a debug method.

A debug system according to the present invention comprises a host computer for executing a debugger program; and a circuit having a complex system constructed thereon including a first multi-task system to be debugged by the debugger program and a second multi-task system which is not a target of debug. The circuit includes a memory having a program stored thereon and a processor capable of executing the program on the memory. The memory has a first operating system for managing at least one task program included in the first multi-task system; and a second operating system for managing the first operating system as a first task program and managing at least one second task program different from the first task program.

The memory may further have a monitor program for controlling execution of the first multi-task system. The processor may execute the monitor program in response to a command from the host computer which has executed the debugger program, execute a process corresponding to the command, and return a response to the host computer.

The memory may have the second operating system and the at least one second task program as the second multi-task system stored thereon.

The memory may have a third operating system and a third task program managed by the third operating system stored thereon as the at least one second task program. The memory may store the third operating system and the third task program as the second multi-task system.

The circuit may further have a stack; and the processor may save an environment for executing the first multi-task system in the stack, and then suspend execution of the at least one task program included in the first multi-task system based on the monitor program.

The processor may suspend the execution of the first operating system when suspending the execution of the at least one task program included in the first multi-task system.

When the process reaches a preset break point, the processor may suspend the execution of the first operating system and suspend the execution of the at least one task program included in the multi-task system.

When an exception occurs in the process, the processor may suspend the execution of the first operating system and suspend the execution of the at least one task program included in the multi-task system.

The processor may be capable of executing an interruption process of the first multi-task system on the first operating system, and execute the interruption process of the first multi-task system with priority over any of the at least task program included in the first multi-task system.

The processor may be capable of executing an interruption process of the first multi-task system on the first operating system, and execute the interruption process of the first multi-task system with priority over any task program included in the complex system.

The first operating system executed by the processor may manage the interruption process as an interruption task program, and the processor may execute the interruption task program with priority over any of the at least one task program included in the first multi-task system.

The first operating system executed by the processor may manage the interruption process as an interruption task program, and the processor may execute the interruption task program with priority over any task program included in the complex system.

A circuit according to the present invention is connected to a host computer for executing a debugger program and has a complex system constructed thereon including a first multi-task system to be debugged by the debugger program and a second multi-task system which is not a target of debug. The circuit comprises a memory having a program stored thereon; and a processor capable of executing the program on the memory. The memory has a first operating system for managing at least one task program included in the first multi-task system; and a second operating system for managing the first operating system as a first task program and managing at least one second task program different from the first task program.

A circuit according to the present invention is connected to a host computer for executing a debugger program and is capable of having a complex system constructed thereon including a first multi-task system to be debugged by the debugger program and a second multi-task system which is not a target of debug. The circuit comprises a memory having a program stored thereon; and a processor capable of executing the program on the memory. The memory has a first operating system; and a second operating system for managing the first operating system as a first task program and managing at least one second task program different from the first task program. When at least one task program is read into the memory, the first operating system may manage the at least one task program as a task program of the first multi-task system.

According to a debug system of the present invention, a first multi-task system, which is a target of debug, is managed by a first OS, and the first OS is managed as a task by a second OS. The second multi-task system is also managed by the second OS. Since the second OS manages the first OS as one task, the priority levels of the tasks can be determined with no influence by the tasks of the first multi-task system.

For example, when a task of the first multi-task system has a bug or the like, the priority levels of the tasks managed by the second OS are not changed due to the bug. The reason is that a change of the priority level of the task having a bug influences only the other tasks managed by the first OS, and does not influence the tasks managed by the second OS.

Since the second OS does not need to manage the tasks of the first multi-task system, the processing load required for executing the second OS can be alleviated.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 shows a structure of a first optical disc system developed by a debug function according to a first embodiment of the present invention.

FIG. 2 shows a structure of a second optical disc system developed by a debug function according to the first embodiment.

FIG. 3 shows a structure of a large scale semiconductor integrated circuit (LSI) 109 having a complex multi-task system constructed thereon.

FIG. 4 is a schematic view showing an overall structure of a debug system according to the first embodiment.

FIG. 5 shows a CPU 111 and an interruption control device 112 in detail.

FIG. 6 is a flowchart illustrating an example of a process of suspending a debug target multi-task system.

FIG. 7 is a flowchart illustrating an example of a process of resuming the debug target multi-task system.

FIG. 8 is a schematic view showing an overall structure of a debug system according to a second embodiment of the present invention.

FIG. 9 is a flowchart illustrating an example of a process of making a determination on an interruption.

FIG. 10 is a flowchart illustrating an example of a process of starting an interruption processing task according to the second embodiment.

FIG. 11 is a flowchart illustrating an example of a process of terminating the interruption processing task according to the second embodiment.

FIGS. 12A and 12B are timing diagrams illustrating task transfer when an interruption occurs according to the second embodiment.

FIG. 13 shows states of ready queues of a first OS task and a second OS according to the second embodiment.

FIG. 14 shows a structure of tasks in the case where a non-debug target multi-task system is managed by an OS task.

FIG. 15 is a flowchart illustrating an example of a process of starting an interruption processing task according to a third embodiment of the present invention.

FIG. 16 is a flowchart illustrating an example of a task dispatch process by a second OS according to the third embodiment.

FIG. 17 is a flowchart illustrating an example of a process of terminating the interruption processing task according to the third embodiment.

FIG. 18 is a timing diagram illustrating task transfer when an interruption occurs according to the third embodiment.

FIG. 19 shows states of ready queues of a first OS task and a second OS according to the third embodiment.

FIG. 20 shows a schematic structure of a conventional optical disc system.

### DETAILED DESCRIPTION OF PREFERRED EMBODIMENTS

Hereinafter, preferred embodiments of the present invention will be described with reference to the accompanying drawings.

### Embodiment 1

Hereinafter, first, a structure and features of an integrated circuit (e.g., an LSI, a VSLI) after a program is debugged by a debug method according to a first embodiment of the present invention will be described. Then, a structure for debugging the program and the debug method will be described.

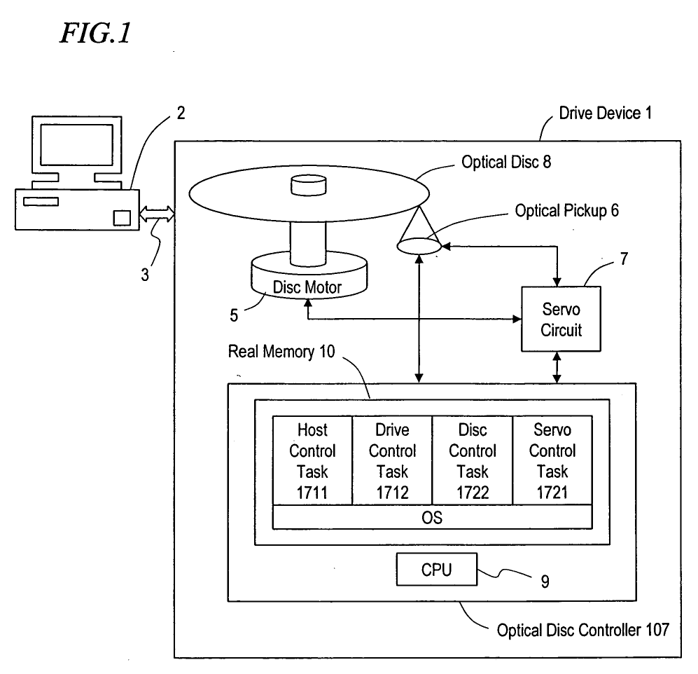

FIG. 1 shows a structure of a first optical disc system developed by a debug function according to this embodiment. The optical disc system includes a drive device 1 capable of having an optical disc 8 mounted thereon and a host computer 2. The drive device 1 and the host computer 2 are connected to each other via a host interface bus 3. In the case where the drive device 1 is used as a computer peripheral such as a DVD-ROM drive or the like, the drive device 1 sends data to and receives data from the host computer 2 via the host interface bus 3 such as a SCSI (Small Computer System Interface) or the like.

The drive device 1 includes a disc motor 5, an optical pickup 6, a servo circuit 7, and an optical disc controller 107. FIG. 1 also shows the optical disc 8 for the sake of easier description, but the optical disc 8 is detachable from the drive device 1 and is not an element of the drive device 1.

The optical disc controller 107 is an LSI for controlling the operation of the drive device 1. The optical disc controller 107 includes at least a CPU 9 and a real memory 10. The control by the optical disc controller 107 is mainly realized by the CPU 9 executing a program read to the real memory 10 and an instruction as a result of the execution being output to the elements of the drive device 1.

The disc motor 5 rotates the optical disc 8 at a predetermined rotation rate. The optical pickup 6 irradiates the optical disc 8 with laser light, detects an amount of light reflected by the optical disc 8, and outputs a light amount signal corresponding to the reflected amount of light. The servo circuit 7 executes focusing control or tracking control based on the light amount signal from the optical pickup 6.

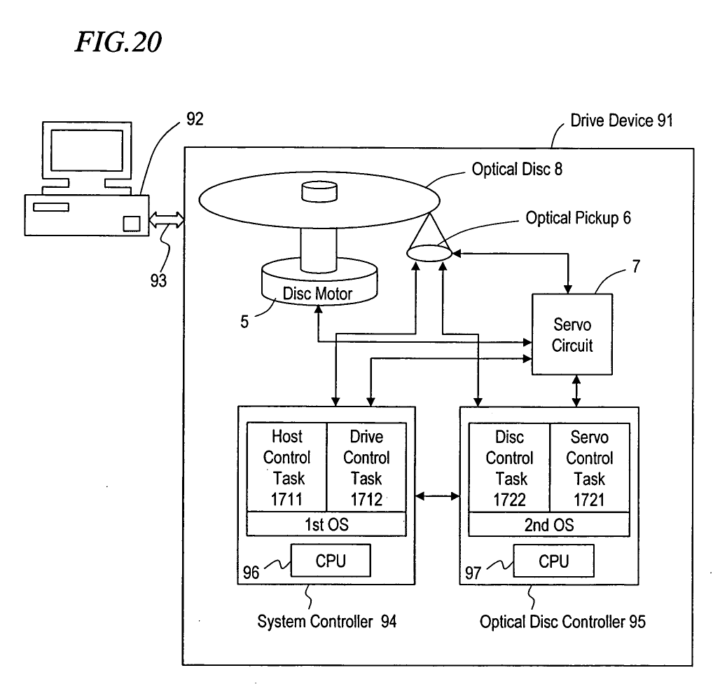

One of primary features of the optical disc system which shows that the debug function according to this embodiment is adopted is that only one LSI (the optical disc controller 107) is implemented on the drive device 1, and functions of the system controller and the optical disc controller work in a single CPU. This means that the functions of the system controller in the conventional drive device 94 (FIG. 20) are incorporated into the optical disc controller 107. Incorporation of the functions into one LSI costs less for the components than implementing a plurality of LSIs.

The CPU 9 of the optical disc controller 107 executes a plurality of programs (a plurality of tasks) via one OS constructed on the real memory 10. The plurality of tasks are, for example, a host control task 1711, a drive control task 1712, a servo control task 1721, and a disc control task 1722, etc.

A specific process executed by each task is as follows. The host control task 1711 controls, for example, the operation of an interface with the host computer 2 and an interface with the user with respect to pressing of switches (not shown). The drive control task 1712 controls, for example, processes of starting and stopping the drive device 1 and a process of buffering data. The servo control task 1721 controls the operation of the servo circuit 7. The disc control task 1722 controls, for example, the reproduction of data.

In order to realize the optical disc system shown in FIG. 1, it is necessary to develop an OS executable on one CPU 9 and cause the OS to manage all the tasks. An LSI vendor sells LSIs to a drive manufacturer in the state where each LSI has a normally operating OS, the servo control task 1721 and the disc control task 1722 already incorporated thereinto. The drive manufacturer can produce the optical disc controller 107 as a complete product by simply creating and debugging the host control task 1711, the drive control task 1712 and the like which are executable on the incorporated OS. Since it is not necessary to develop an OS anew, at least the costs for developing an OS can be saved.

However, in order to develop such an optical disc controller 107, the tasks which are operable on different operating systems need to be modified to be adaptable to the incorporated operating system.

There is also the following problem. When a system call is issued to a task of one multi-task system by a task of another multi-task system, the state of the task of the first multi-task system is changed and malfunctions occur. This system call is, for example, regarding scheduling of tasks (rotation of a ready queue, change of priority levels of tasks).

For example, it is assumed that in the drive device 1 shown in FIG. 1, the drive control task 1712, which is under development, of the optical disc controller 107 has a bug. If the priority level of the disc control task 1722 is made lower than the priority level of the servo control task 1721 by an erroneous processing of the drive control task 1712, the drive device 1 may cause a malfunction of, for example, failing to reproduce the data.

Hereinafter, a structure improved from the structure shown in FIG. 1, and a debug function and a debug method for realizing such an improved structure will be described.

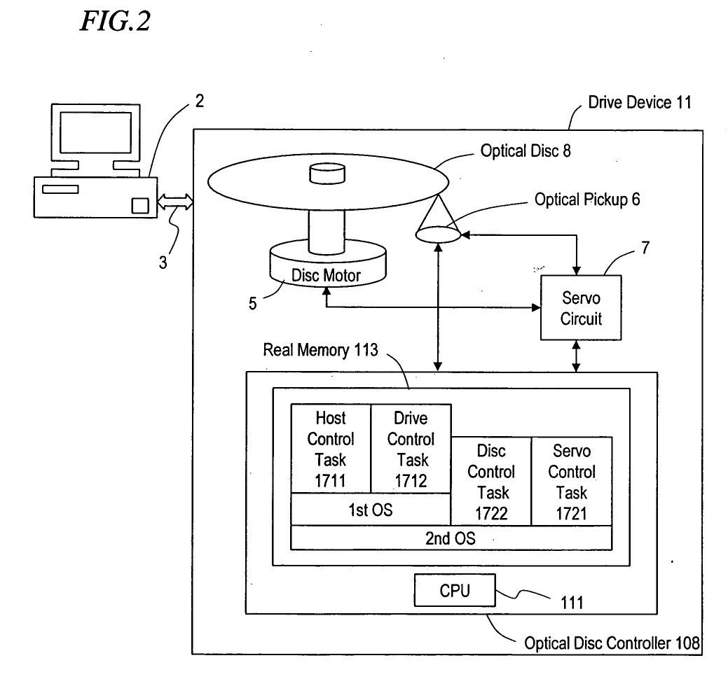

FIG. 2 shows a structure of a second optical disc system developed by a debug function according to this embodiment. Identical elements as those shown in FIG. 1 bear identical reference numerals thereto and detailed descriptions thereof will be omitted.

A drive device 11 of the second optical disc system includes only one LSI (an optical disc controller 108) like the drive device 1 of the first optical disc system. The functions of the system controller are incorporated into the optical disc controller 108.

The optical disc system shown in FIG. 2 is different from the optical disc system shown in FIG. 1 in a program management structure constructed on a real memory 113 of the optical disc controller 108.

Specifically, as shown in FIG. 2, in the optical disc controller 108, the host control task 1711 and the drive control task 1712 are managed by a first OS. The host control task 1711 and the drive control task 1712 together form one multi-task system. The servo control task 1721 and the disc control task 1722 are managed by a second OS. The servo control task 1721 and the disc control task 1722 together form another multi-task system. The first OS is managed by the second OS as one task. In order to make this clear, the first OS will be referred to as a “first OS task” hereinafter.

A CPU 111 of the optical disc controller 108 can directly or indirectly manage all the tasks on the second OS. A comprehensive system including a plurality of multi-task systems is referred to as a “complex multi-task system”.

Next, a structure of a complex multi-task system according to this embodiment and a debug method for the complex multi-task system will be described.

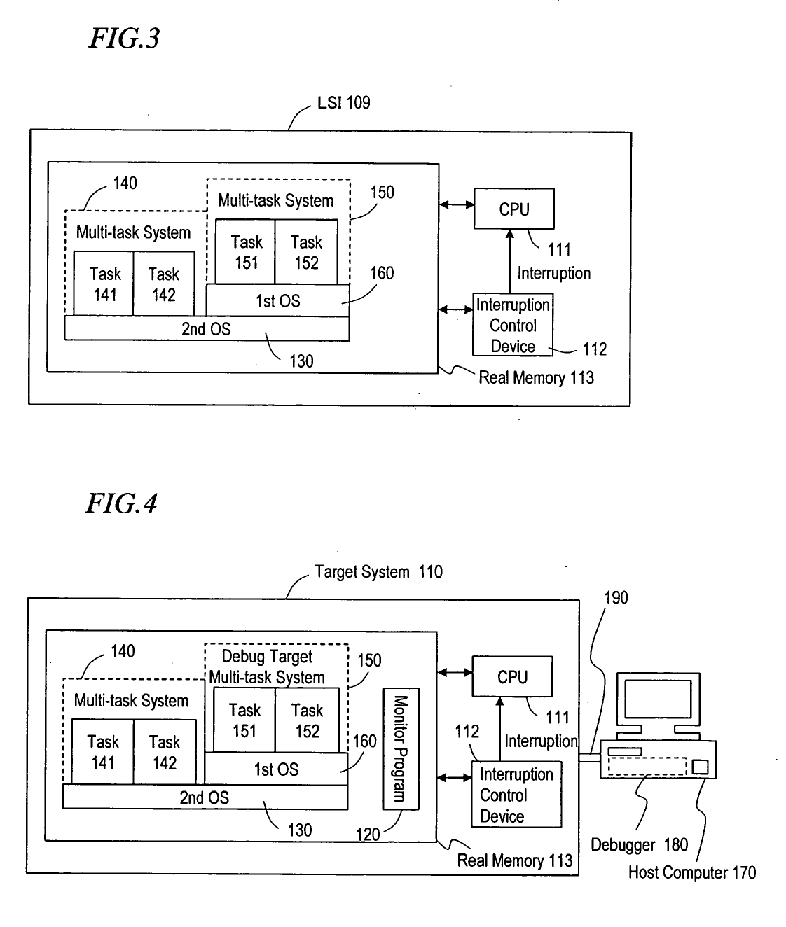

FIG. 3 shows a structure of a large scale semiconductor integrated circuit (LSI) 109 having a complex multi-task system constructed thereon. One example of the LSI 109 is the optical disc controller 108 shown in FIG. 2.

The LSI 109 includes a CPU 111, an interruption control device 112, and a real memory 113. A second OS 130, multi-task systems 140 and 150, and a first OS task 160 have been read into, and located in, the real memory 113. The second OS 130, the multi-task systems 140 and 150, and the first OS 160 are each software (computer program) executable by the CPU 111. The complex multi-task system shown in FIG. 3 includes a plurality of independent multi-task systems 140 and 150, which are processed on one CPU 111.

The multi-task system 140 includes tasks 141 and 142, which are managed by the second OS 130. The multi-task system 150 which is a target of debug (hereinafter, referred to as the “debug target multi-task system 150”), includes tasks 151 and 152, which are managed by the first OS task 160.

Construction of the complex multi-task system shown in FIG. 3 provides an advantage of easily developing the LSI 109. This will be described more specifically below.

First, the first OS task 160 is managed by the second OS 130. This allows the two independent multi-task systems 140 and 150 to be managed by different operating systems, and thus eliminates the necessity of designing all the tasks to be operable on one, same OS. Therefore, the tasks operable on the conventional OS can even be used with no modification. This is made possible by adapting only the first OS task 160 to the second OS 130 and re-developing the first OS task 160 to have the specifications of the conventional OS. Therefore, the costs for developing the LSI 109 can be reduced.

Second, three tasks, i.e., the task 141, the task 142 and the first OS task 160 are managed by the second OS 130. The number of tasks managed by the second OS 130 is reduced as compared to the case where the tasks 141, 142, 151 and 152 are managed by the second OS 130. As a result, numbers of target tasks are reduced in determining priorities of the tasks and easier development is achieved. This advantage becomes more conspicuous as the number of the tasks managed by the first task OS 160 is increased.

Third, the complex multi-task system has an advantage that the influence of one multi-task system exerted on the other multi-task system can be blocked. For example, it is assumed that the task 151 of the debug target multi-task system 150 has issued a system call to rotate the ready queue. However, the influence only reaches the other task 152 managed by the first OS task 160, but does not influence any of the task 141 and the task 142 of the other multi-task system 140 or the first OS task 160.

Hereinafter, a structure of a debug system and a debug method according to this embodiment will be described. The LSI 109 shown in FIG. 3 is obtained by debugging a program using the debug system described below. For example, the optical disc controller 108 shown in FIG. 2 is obtained by debugging an LSI program used for an optical disc device.

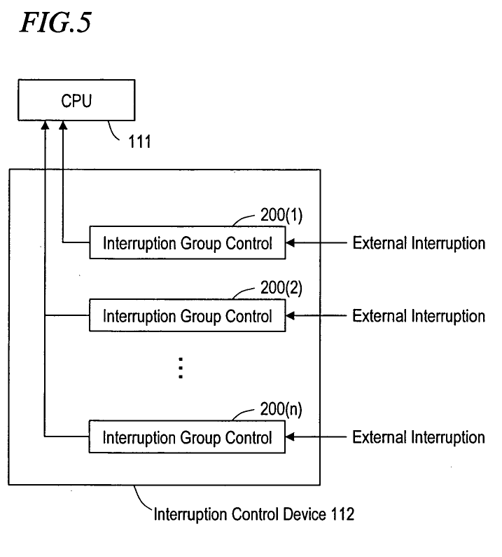

FIG. 4 schematically shows an overall structure of a debug system according to this embodiment. The debug system includes a target system 110 and a host computer 170, which are connected to each other via an interface bus 190.

The target system 110 includes a central processing unit (CPU) 111, an interruption control device 112, and a real memory 113.

A monitor program 120, a second OS 130, a multi-task system 140, a debug target multi-task system 150, and a first OS task 160 have been read into, and located in, the real memory 113. The monitor program 120, the second OS 130, the multi-task system 140, the debug target multi-task system 150, and the first OS task 160 are each software (computer program) executable by the CPU 111. The target system 110 includes a plurality of independent multi-task systems 140 and 150, which are processed on one CPU 111. Therefore, the target system 110 is a complex task system.

The multi-task system 140 includes tasks 141 and 142, which are managed by the second OS 130. The debug target multi-task system 150 includes tasks 151 and 152, which are managed by the first OS task 160. The first OS task 160 is one of the tasks managed by the second OS 130. The structure and operation of the CPU 111 and the interruption control device 112 will be described later with reference to FIG. 5.

The host computer 170 has a debugger 180 incorporated thereinto. The debugger 180 is software for finding a bug of a program and supporting the recovery thereof. The debugger 180 has been read into a real memory (not shown) in the host computer 170 and is executed by a CPU of the host computer 170.

The target system 110 is connected to the host computer 170 via the interface bus 190.

The monitor program 120 is started by an interruption which is caused by communication from the debugger 180. The started monitor program 120 receives a debug command from the debugger 180, executes a process corresponding to the received command, and returns a response to the debugger 180. In this manner, data of the debug target multi-task system 150 is referred to and changed, a break point and the like are set, and the execution of the debug target multi-task system 150 is controlled. For example, the monitor program 120 receives a command requesting the monitor program 120 to refer to the data as well as an address of the data to be referred to, from the debugger 180. The monitor program 120 then obtains the data from the designated address and returns the obtained data to the debugger 180. Thus, the user can confirm the data. The “break point” refers to a specific row at which the execution of a program is discontinued (a position on the program).

FIG. 5 shows a structure of the CPU 111 and the interruption control device 112 in detail. In FIG. 5, elements shown in FIG. 4 bear the identical reference numerals. FIG. 5 shows an example of a system capable of accepting interruptions from n number of interruption groups. An interruption from a peripheral connected to the CPU 111 (for example, an interruption from a keyboard (not shown) to which a key input has been made) is sent to the CPU 111 via the interruption control device 112. The CPU 111, which has accepted the interruption, discontinues the program currently executed and starts executing an interruption processing program. The interruption control device 112 includes interruption group control sections 200(1) through 200(n), and controls interruptions to be sent to the CPU 111. The interruption group control sections 200(1) through 200(n) each include an interruption control register (not shown) and can each set an interruption priority level and interrupt permission/prohibition.

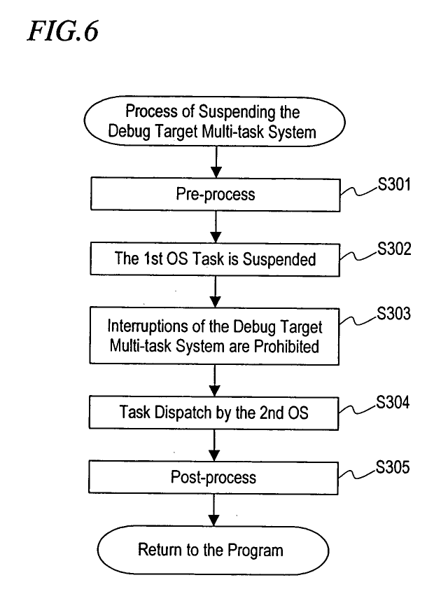

With reference to FIG. 6, a process of suspending the task 151 of the debug target multi-task system 150 at the time when a preset break point is reached or when an exception occurs will be described. FIG. 6 is a flowchart illustrating an example of a process of the monitor program 120 of suspending the debug target multi-task system 150. As described above, the monitor program 120 is executed by the CPU 111. When the program of the task 151 of the debug target multi-task system 150 reaches a break point, or when an exception occurs, the control is switched to a multi-task system suspending process of the monitor program 120.

First in step S301, a pre-process is performed. A “pre-process” is to save a group of registers of the task 151 currently executed, and values of a program counter, a status register and the like in a stack (not shown) or the like constructed on the real memory 113. By this processing, the environment for executing the tasks of the debug target multi-task system 150 is retained. The above-mentioned registers and values may be saved in a part of the real memory 113 other than the stack or other memories (not shown) instead of the stack.

In step S302, the CPU 111 issues a system call to the second OS 130 for transferring the first OS task 160 to a suspended state. As a result, the execution of the first OS task 160 is suspended. At this point, in response to the system call, the second OS 130 executes a process of transferring the first OS task 160 to the suspended state.

Next in step S303, the CPU 111 prohibits all the interruption of the debug target multi-task system 150. The interrupt prohibition is realized by, for example, setting a register for controlling interruptions of the debug target multi-task system 150, among the interruption control registers of the interruption control device 112, to an interruption prohibited state.

In step S304, the CPU 111 executes a task dispatch process by the second OS 130. The “task dispatch process by the second OS 130” means that the second OS 130 schedules the execution order of the tasks based on the priority levels of the tasks, and switches the target to be executed by the CPU 111 to the task having the highest priority level. (Hereinafter, “task dispatch” will be referred to simply as “dispatch”) In this example, the dispatch process switches the first OS task 160 to another task having the highest priority level (the task 141 or the task 142). Thus, the execution of the plurality of tasks of the debug target multi-task system 150 (the tasks 151 and 152) is suppressed.

Then, in step S305, a post-process including the restoration of the register of the post-switch task having the highest priority level (the task 141 or the task 142) is executed. Then, the execution of the monitor program 120 is finished.

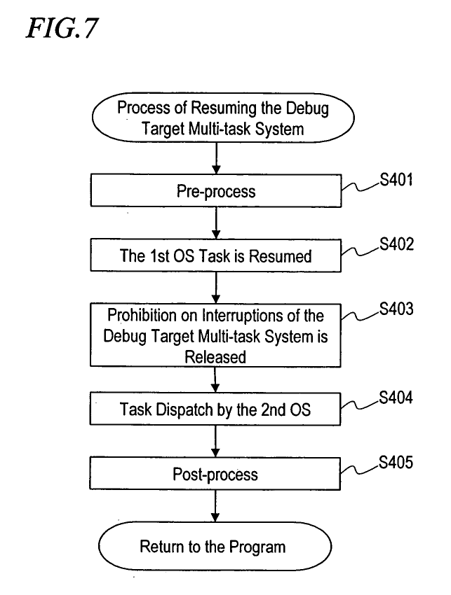

Next, with reference to FIG. 7, a process of resuming the debug target multi-task system 150 which was once suspended will be described. This process is performed after the debug target multi-task system 150 is debugged.

FIG. 7 is a flowchart illustrating an example of a process of the monitor program 120 of resuming the execution of the debug target multi-task system 150. First, at an arbitrary time, the user instructs the execution of the debug target multi-task system 150 to be resumed via the debugger 180. Then, the control is switched to a multi-task system resuming process of the monitor program 120.

In step S401, the CPU 111 executes a pre-process including the saving of the register of the task currently executed. This is the same as the process performed in step S301. In step S402, the CPU 111 issues a system call to the second OS 130 for resuming the execution of the first OS task 160. In response to the system call, the second OS 130 places the first OS task 160, which has been in the suspended state, to a ready state.

Next in step S403, the CPU 111 releases the prohibition on interruptions of the debug target multi-task system 150. As a result, the interruptions which have been prohibited since step S303 are permitted.

In step S404, the CPU 111 executes a dispatch process by the second OS 130. Then, when the resumption of the execution of the first OS task 160 is permitted, a post-process including the restoration of the registers of the tasks is executed. Then, the environment for executing the tasks is recovered.

As a result of the above-described processes, the execution of the plurality of tasks of the debug target multi-task system 150 (the tasks 151 and 152) can be resumed.

According to this embodiment, the debug target multi-task system 150 is managed by the first OS task 160. At the time when an arbitrary task of the debug target multi-task system 150 (the task 151 or 152) reaches the break point, or when an exception occurs, the execution of the first OS task 160 is suspended. Thus, the execution of all the tasks included in the debug target multi-task system 150 (the tasks 151 and 152) can be suppressed while the environment for executing the tasks is retained.

Even when, while the execution of the debug target multi-task system 150 is at a pause, a system call for changing the state of the tasks is issued to the second OS 130 by, for example, another task currently executed, such a system call does not influence the tasks 151 and 152 of the debug target multi-task system 150, which are managed by the first OS task 160. This facilitates debug of the multi-task systems.

When a system call to change status of the tasks is issued by the tasks 151 and 152 of the debug target multi-task system 150, the influence does not reach the tasks 141 and 142 of the other multi-task system 140 and the first task 160, but reaches the task(s) managed by the first OS 160.

A purchaser of an LSI having an OS or basic tasks incorporated therein can develop, for example, a drive control task and a host control task as the tasks 151 and 152 and incorporate the tasks 151 and 152 into the LSI after debugging. In this manner, the optical controller 108 of the drive device 1 (FIG. 2) can be obtained.

In this embodiment, at the time when the break point is reached, or when an exception occurs, the execution of the first OS task 160 is suspended by a system call for placing the first OS task 160 into a suspended state. Alternatively, the execution of the first OS task 160 may be suspended by a system call for placing the first OS task 160 into a wait state. The first OS task 160 may be placed into any state as long as the execution of the first OS task 160 is suppressed.

In this embodiment, the target system 110 includes two multi-task systems 140 and 150. The present invention is applicable to the case where the target system 110 includes three or more multi-task systems. In this embodiment, each multi-task system 140, 150 includes two tasks. The present invention is also applicable to the case where one of, or both of, the multi-task systems 140 and 150 include three or more tasks.

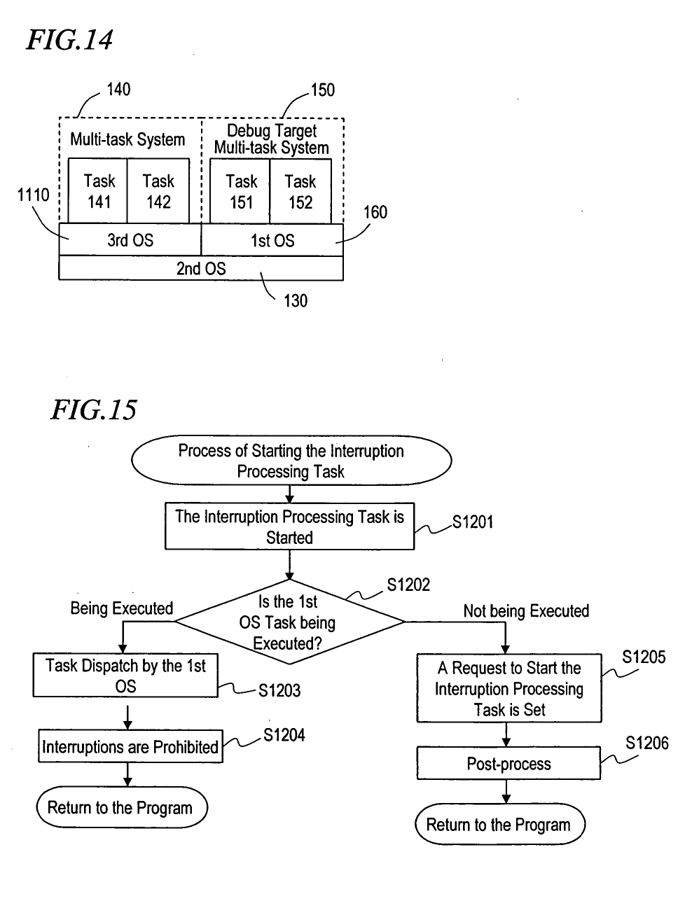

In this embodiment, the second OS 130 manages the first OS task 160 and the multi-task system 140 which is not a target of debug, and the first OS task 160 manages the debug target multi-task system 150. Alternatively, an OS for managing a debug target multi-task system and an OS for managing a multi-task system which is not a target of debug (hereinafter, referred to also as a “non-debug target multi-task system) may be provided, and a comprehensive OS for managing these operating systems as tasks may be provided. For example, FIG. 14 shows a management structure of a system according to a modification of this embodiment. In this system, the first OS task 160 manages the debug target multi-task system 150, and a third OS 1110 manages the non-debug target multi-task system 140. The second OS 130 manages the first OS task 160 and the third OS 1110 as tasks. With such a management structure, even in the case where there are two or more non-debug target multi-task systems, each such multi-task system can be managed by an OS task, and these OS tasks can be managed by the second OS 130. Therefore, the tasks can be processed uniformly, and a highly multi-purpose system can be constructed. Since the second OS 130 is only needed to be designed to manage one OS task, the costs for the development can be reduced.

In this embodiment, a debug system for obtaining the multi-task system of the optical disc controller 107 shown in FIG. 1 is not described. Such a debug system can be obtained by, for example, eliminating the first OS task 160 from the target system 110 shown in FIG. 4. As described above, it is necessary to, for example, develop each task so as to be adaptable to one, same OS in this case.

### Embodiment 2

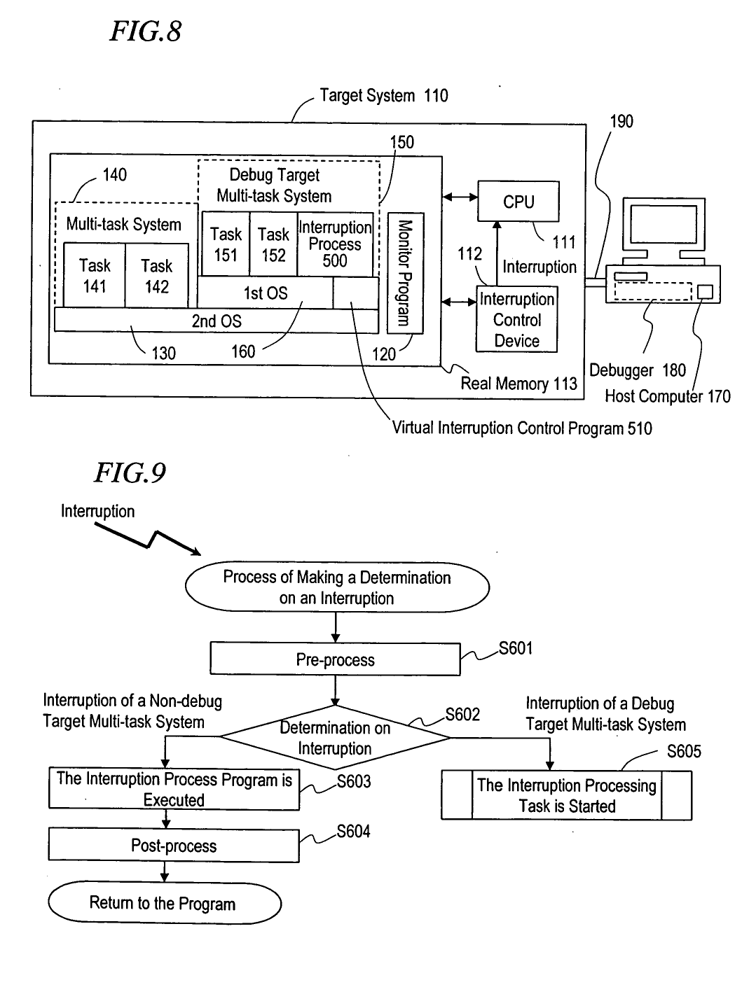

FIG. 8 schematically shows an overall structure of a debug system according to a second embodiment of the present invention. Identical elements as those shown in FIG. 4 bear identical reference numerals thereto. Identical elements as those described above regarding the first embodiment bear identical reference numerals thereto and detailed descriptions thereof will be omitted.

The debug system according to this embodiment includes a virtual interruption control program 510 located in the real memory 113 in addition to the structure of the debug system described in the first embodiment (FIG. 4). The debug target multi-task system 150 includes tasks 151 and 152 and an interruption process 500.

Hereinafter, a virtual interruption process will be described. With the virtual interruption process according to this embodiment, the interruption process 500 of the debug target multi-task system 150 is managed by the first OS task 160 as a task. (Hereinafter, the interruption process 500 will be referred to also as the “interruption processing task 500”). The interruption processing task 500 is executed with priority over the other tasks (the tasks 141, 142, 151 and 152) by the virtual interruption control program 510.

The priority levels of the tasks shown in FIG. 8 are as follows. The priority levels of the tasks managed by the first OS task 160 are:
the interruption processing task 500>the other tasks (the tasks 151 and 152).

When the interruption processing task 500 is started, the priority levels of the tasks managed by the second OS 130 are:
the first OS task 160>the other tasks (the tasks 141 and 142).

In the case where the debug target multi-task system 150 includes a plurality of interruption processing tasks, these interruption processing tasks can be provided with different priority levels, so that level interruption is executed in the virtual interruption process. For example, it is assumed that the debug target multi-task system 150 has interruption 1 and interruption 2 (priority level: interruption 1>interruption 2), and interruption processing tasks for the respective interruptions are interruption processing task 1 and interruption processing task 2. The priority levels of the tasks are set to:
interruption processing task 1>interruption processing task 2.

In this manner, a virtual interruption process corresponding to the level interruption can be executed.

Next, processes for starting and terminating the interruption processing task 500 of the virtual interruption control program 510 will be described.

FIG. 9 is a flowchart illustrating an example of a process of making a determination on an interruption. In step S601, when an interruption occurs, the control is switched to an interruption determining process of the virtual control program 510. The CPU 111 executes a pre-process including the saving of the registers and the switching of the stacks. Next in step S602, the CPU 111 determines whether or not the interruption is an interruption of the debug target multi-task system 150. When it is such an interruption, the process goes to step S605, whereas when it is not such an interruption, the process goes to step S603.

In step S603, the CPU 111 executes an interruption processing program in a similar manner to a general interruption process. In step S604, the CPU 111 executes a post-process including the restoration of the registers and the dispatch process, and then returns from the interruption.

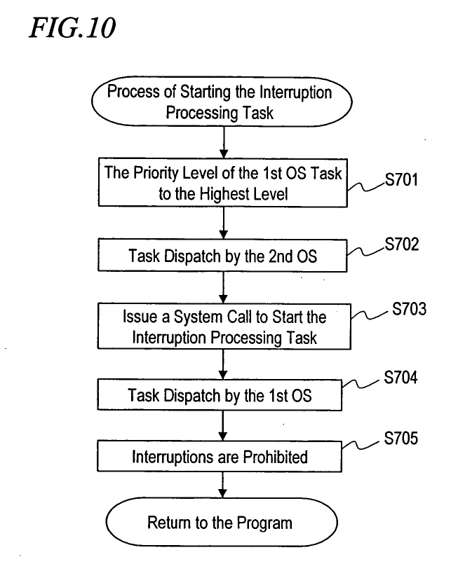

In step S605, the CPU 111 executes a process of starting the interruption processing task 500. This will be described in detail with reference to FIG. 10.

FIG. 10 is a flowchart illustrating an example of a process of starting the interruption processing task 500. First in step S701, the CPU 111 issues a system call to the second OS 130 for changing the priority level of the first OS task 160. Thus, the priority level of the first OS task 160 is changed to the highest level. In step S702, the CPU 111 executes a dispatch process by the second OS 130. As a result, the target of execution is switched to the first OS task 160 having the highest priority level.

Next in step S703, the CPU 111 issues a system call to the first OS task 160 for starting the interruption processing task 500. In step S704, the CPU 111 executes a dispatch process by the first OS task 160. As a result, the interruption processing task 500 having the highest priority level is dispatched.

In step S705, the CPU 111 prohibits all the interruptions of the debug target multi-task system 150. Then, the CPU 111 returns from the interruption and executes the interruption processing task 500.

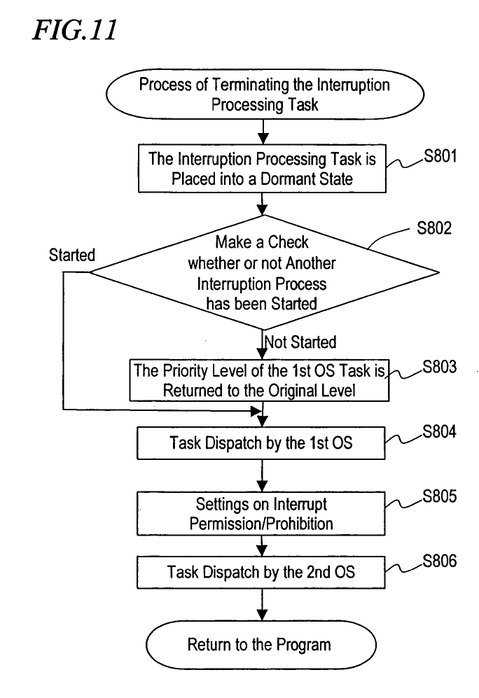

Next, with reference to FIG. 11, a process for terminating the interruption processing task 500 will be described. FIG. 11 is a flowchart illustrating an example of a process of terminating the interruption processing task 500. In step S801, the CPU 111 removes the interruption processing task 500 from a ready queue of the first OS task 160 and places the interruption processing task 500 into a dormant state. The “ready queue” is a queue used for managing a task in a ready state. A task, when being placed into a ready state, is located in a wait queue in accordance with the priority level thereof. This wait queue is referred to as a “ready queue”.

Next in step S802, the CPU 111 checks whether or not another interruption processing task has been started. When no other interruption processing task has been started, the process goes to step S803. When another interruption processing task has been started, the process goes to step S804.

In step S803, the CPU 111 issues a system call to the second OS 130 for changing the priority level of the first OS task 160 in order to return the priority level of the first OS task 160 to the original level.

In step S804, the CPU 111 executes a dispatch process by the first OS task 160. As a result, the target of execution is switched to a task having the highest priority level at this point.

In step S805, in order to permit or prohibit an interruption of the debug target multi-task system 150 in accordance with the interrupt state of a task which has been placed into a running state by the dispatch process, the CPU 111 executes an interrupt permission/prohibition setting process of the debug target multi-task system 150. For example, in the case where the task which was placed into a running state after the dispatch process by the first OS task 160 in step S804 is, for example, an interruption processing task in an interrupt prohibited state, the CPU 111 sets the interrupts of the debug target multi-task system 150 to an interrupt prohibited state. In the case where the task which was placed into a running state after the dispatch process by the first OS task 160 in step S804 is, for example, a task in an interrupt permitted state, the CPU 111 sets the interrupts of the debug target multi-task system 150 to an interrupt permitted state.

The interrupt permission/prohibition setting process is realized as follows. The first OS task 160 retains information for managing whether each task (the task 151, the task 152, and the interruption processing task 500) is in an interrupt permitted state or an interrupt prohibited state. (Hereinafter, such information will be referred to as the “interrupt management information”.) For example, the first OS task 160 retains an interrupt permitting flag indicating that an interrupt of the task is permitted and an interrupt mask level for setting an acceptable interrupt level, in a task control block (TCB). Then, the CPU 111 can refer to the interrupt management information of the task which was placed into a running state by the dispatch process by the first OS task 160, and set the debug target multi-task system 150 to an interrupt permitted state or an interrupt prohibited state. For example, among the interrupt control registers of the interrupt control device 112, an interrupt control register for controlling an interrupt of the debug target multi-task system 150 is set to an interrupt permitted state or an interrupt prohibited state.

Next in step S806, the CPU 111 executes a dispatch process by the second OS 130. As a result, the task having the highest priority level at this point is executed.

As described above, an interrupt process is managed by the first OS task 160 as one task, and the interruption processing task 500 is executed with priority over the other tasks (the tasks 141, 142, 151 and 152) by the virtual interrupt control program 510. Since the priority levels can be set, the interruption processing task 500 can be executed like a general interrupt process.

Next, a process of suspending the tasks of the debug target multi-task system (the tasks 151 and 152) and the interruption processing task 500 will be described.

The process of suspending a task of the debug target multi-task system 150 (the task 151 or 152) is executed at the time when an arbitrary task included in the debug target multi-task system 150 (the task 151 or 152) reaches the break point or when an exception occurs, like in the first embodiment. At this point, the CPU 111 suspends the execution of the first OS task 160. The interrupt process 500 of the debug target multi-task system 150 is managed by the first OS task 160. Therefore, the execution of the first OS task 160 is suspended at the time when the break point is reached or when an exception occurs as in the case of a general task (the task 151 or 152). Thus, the execution of the debug target multi-task system 150 is suspended. A process of resuming the execution of the debug target multi-task system 150, which has been once suspended, is performed in the same manner as in the first embodiment.

Next, an exemplary operation of the virtual interrupt process will be described. In this example, the task 141 is being executed and the interruption processing task 500 has not been started. The priority levels of the tasks managed by the second OS 130 are:
the task 141 (priority level 2)>the task 142 (priority level 3)>the first OS task 160 (priority level 4).

When the priority level of the first OS task 160 is made highest for starting the interruption processing task 500, the priority levels of the tasks are set as follows:
the first OS task 160 (priority level 1)>the task 141 (priority level 2)>the task 142 (priority level 3).

The priority levels of the tasks managed by the first second OS task 160 are:
the interruption processing task 500 (priority level 1)>the task 151 (priority level 2)>the task 152 (priority level 3).

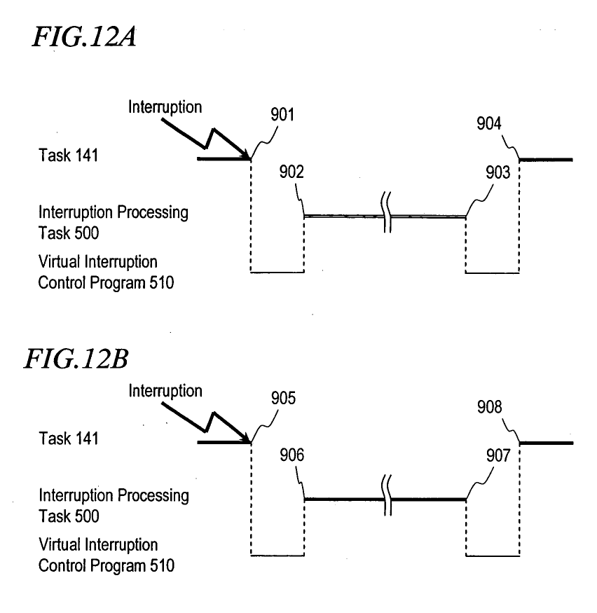

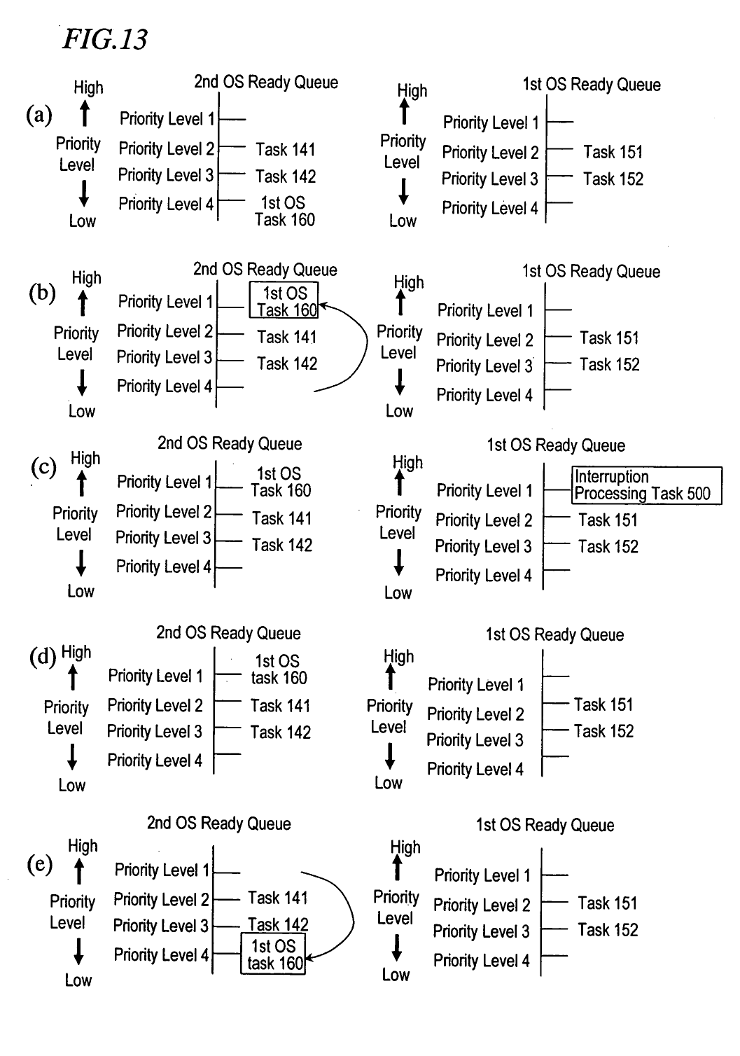

FIG. 12A shows timing of task transfer when an interrupt of a debug target multi-task system 150 occurs. FIG. 12B shows timing of task transfer when an interrupt of a non-debug target multi-task system 140 occurs. FIG. 13 shows the states of the ready queues of the first OS task 160 and the second OS 130 in the processes of starting and terminating the interruption processing task 500.

First, an operation of the virtual interrupt process when an interrupt of the debug target multi-task system 150 occurs will be described.

As indicated by reference numeral 901 in FIG. 12A and portion (a) of FIG. 13, when an interrupt of the debug target multi-task system 150 occurs, the CPU 111 switches the control to an interrupt determining process of the virtual interrupt control program 510. Then, the CPU 111 executes a pre-process including the saving of the registers and the switching of the stacks (step S601 in FIG. 9). Next, the CPU 111 determines whether or not the interrupt is an interrupt of the debug target multi-task system 150 (step S602). Since the interrupt is an interrupt of the debug target multi-task system 150 in this example, the process of starting the interruption processing task 500 is executed (step S605).

Next, as shown in portion (b) of FIG. 13, the CPU 111 issues a system call to the second OS 130 for changing the priority level of the first OS task 160 to the highest level (step S701 in FIG. 10), and executes a dispatch process by the second OS 130 (step S702). As a result, the target of execution is switched from the task 141 to the first OS task 160 having the highest priority level. Then, as shown in portion (c) of FIG. 13, the CPU 111 issues a system call to the first OS task 160 for starting the interruption processing task 500 (step S703), and executes a dispatch process by the first OS task 160 (step S704). As a result, the interruption processing task 500 having the highest priority level becomes the target of execution. Next, the CPU 111 prohibits all the interrupts of the debug target multi-task system 150 (step S705), returns from the interrupt, and starts the execution of the interruption processing task 500 (902 in FIG. 12A).

When the execution of the interruption processing task 500 is finished (903 in FIG. 12A), as can be seen from portion (d) of FIG. 13, the CPU 111 removes the interruption processing task 500 from the ready queue of the first OS task 160 and transfers the interruption processing task 500 to a dormant state (step S801 in FIG. 11). Next, the CPU 111 checks whether or not another interruption processing task has been started (step S802).

Since no interruption processing task has been started in this example, the CPU 111 issues a system call to the second OS 130 for changing the priority level of the first OS task 160 as shown in portion (e) of FIG. 13 in order to return the priority level of the first OS task 160 to the original level (step S803). Then, the CPU 111 executes a dispatch process by the first OS task 160 (step S804). As a result, the task 151 is placed into a running state, and the CPU 111 sets the interrupts of the debug target multi-task system 150 to an interrupt permitted state or an interrupt prohibited state in accordance with the interrupt state of the task 151 (step S805 in FIG. 11). The CPU 111 also executes a dispatch process by the second OS 130 (step S806). As a result, the task 141 having the highest priority level at this point is executed (904 in FIG. 12A).

Next, an operation of the virtual interrupt process when an interrupt of the non-debug target multi-task system 140 occurs will be described.

When an interrupt occurs (905 in FIG. 12B), the CPU 111 switches the control to an interrupt determining process of the virtual interrupt control program 510. Then, the CPU 111 executes a pre-process including the saving of the registers and the switching of the stacks (step S601 in FIG. 9). Next, the CPU 111 determines whether or not the interrupt is an interrupt of the debug target multi-task system 150 (step S602). Since the interrupt is not an interrupt of the debug target multi-task system 150 in this example, the process goes to an interruption processing program (step S603 in FIG. 9, 906 in FIG. 12B). After the execution of the interruption processing program, the process returns to the virtual interrupt process (907 in FIG. 12B). Then, the CPU 111 executes a post-process including the restoration of the registers and the dispatch process (step S604), and then returns from the interrupt (908 in FIG. 12B).

According to this embodiment, the following effects are provided in addition to the effects described in the first embodiment. According to the second embodiment, the interrupt process of the debug target multi-task system 150 is managed by the first OS task 160 by the virtual interrupt process of performing an operation equivalent to the interrupt process. At the time when the break point is reached, or when an exception occurs, the execution of the first OS task 160 is suspended. As a result, the execution of all the tasks included in the debug target multi-task system 150 (the tasks 151 and 152) and the interruption processing task 500 can be suppressed while the environment for executing the tasks is retained. This makes it possible to debug the entire multi-task system including the interrupt process 500, and thus debug is facilitated.

In this embodiment, the target system 110 includes two multi-task systems 140 and 150. The present invention is applicable to the case where the target system 110 includes three or more multi-task systems. In this embodiment, each multi-task system 140, 150 includes two tasks. The present invention is applicable to the case where one of, or both of, the multi-task systems 140 and 150 include three or more tasks. In this embodiment, the debug target multi-task system 150 has one interrupt process. The present invention is applicable to the case where the debug target multi-task system 150 has two or more interrupt processes.

In this embodiment, the non-debug target multi-task system 140 is managed by the second OS 130. Alternatively, the non-debug target multi-task system 140 may be managed by an OS task which is managed by the second OS 130. Even in the case where there are two or more non-debug target multi-task systems, each such multi-task system may be managed by an OS task, and these OS tasks may be managed by the second OS 130.

In this embodiment, in the process of prohibiting an interrupt in the process of starting the interruption processing task 500 (step S705 in FIG. 10), and in the process of permitting/prohibiting an interrupt in the process of terminating the interruption processing task 500 (S805 in FIG. 11), all the interrupts of the debug target multi-task system 150 are permitted or prohibited. Alternatively, all the interrupts of the debug target multi-task system 150 and the multi-task system 140 may be permitted or prohibited.

### Embodiment 3

An overall structure of a debug system according to a third embodiment of the present invention is the same as that in the second embodiment described above with reference to FIG. 8. Elements and operations thereof which are the same as those in the second embodiment will not be described.

Hereinafter, a virtual interrupt process according to this embodiment will be described. According to the virtual interrupt process of this embodiment, the interrupt process 500 of the debug target multi-task system 150 is managed by the first OS task 160 as a task (interruption processing task), and the interruption processing task 500 is executed with priority over the tasks of the debug target multi-task system (the tasks 151 and 152) by the virtual interrupt control program 510. Hereinafter, this will be described in detail.

The priority levels of the tasks shown in FIG. 8 are as follows. The priority levels of the tasks managed by the first OS task 160 are:
the interruption processing task 500>the other tasks (the tasks 151 and 152).

The priority levels of the tasks managed by the second OS 130 are not specifically determined.

In the case where the debug target multi-task system 150 includes a plurality of interruption processing tasks, these interruption processing tasks can be provided with different priority levels, so that level interrupt is executed by the virtual interrupt process like in the second embodiment.

Next, processes for starting and terminating the interruption processing task 500 of the virtual interrupt control program 510 in this embodiment will be described. The process for making a determination on an interrupt is executed as shown in FIG. 9.

When an interrupt occurs, the CPU 111 switches the control to an interrupt determining process of the virtual control program 510. The CPU 111 executes a pre-process including the saving of the registers and the switching of the stacks (step S601 in FIG. 9). Next, the CPU 111 determines whether or not the interrupt is an interrupt of the debug target multi-task system 150 (step S602 in FIG. 9).

When it is not such an interrupt, the CPU 111 executes an interruption processing program in a similar manner to a general interrupt process (step S603 in FIG. 9), executes a post-process including the restoration of the registers and the dispatch process (step S604 in FIG. 9), and then returns from the interrupt.

When it is an interrupt of the debug target multi-task system 150, the CPU 111 executes a process of starting the interruption processing task 500 (step S605 in FIG. 9) as shown in FIG. 15.

FIG. 15 is a flowchart illustrating an example of a process of starting the interruption processing task 500 according to this embodiment.

First in step S1201, the CPU 111 issues a system call to the first OS task 160 for starting the interruption processing task 500. In step S1202, the CPU 111 checks whether or not the first OS task 160 is being executed. When the first OS task 160 is being executed, the process goes to step S1203, whereas when the first OS task 160 is not being executed, the process goes to step S1205.

In step S1203, the CPU 111 executes a dispatch process by the first OS task 160. As a result, the interruption processing task 500 having the highest priority level is dispatched. In step S1204, the CPU 111 prohibits all the interrupts of the debug target multi-task system 150, then returns from the interrupt, and executes the interruption processing task 500.

In step S1205, the CPU 111 sets a request to start an interruption processing task 500 in order to dispatch the interruption processing task 500 after the first OS task 160 is dispatched. Such a request is set by, for example, setting a start request flag for the interruption processing task 500. Next in step S1206, the CPU 111 executes a post-process including the restoration of the registers, and then returns from the interrupt.

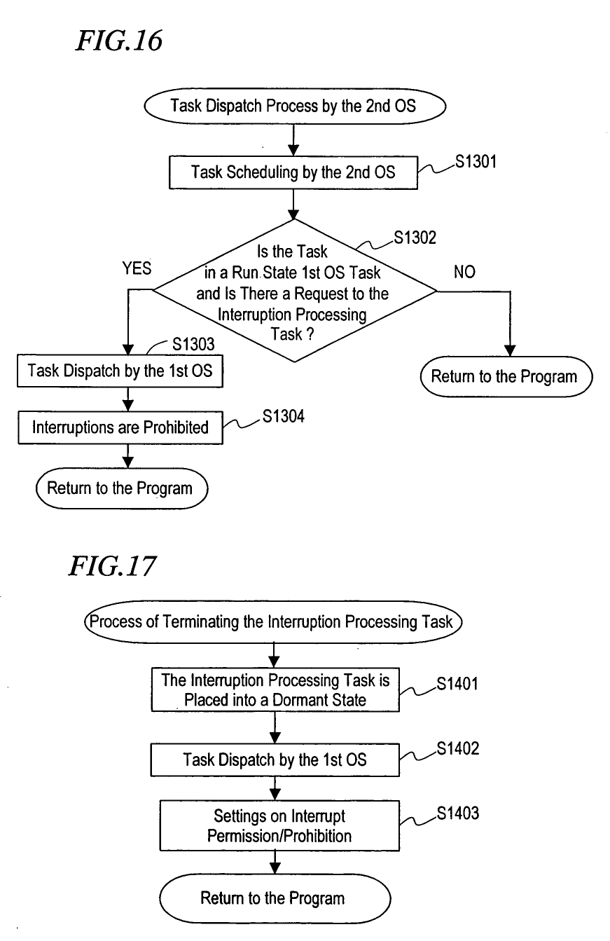

Hereinafter, a process of dispatching the interruption processing task 500 of the first OS task 160 after the first OS task 160 is dispatched will be described. FIG. 16 is a flowchart illustrating an example of a dispatch process by the second OS 130.

First in step S1301, the CPU 111 executes task scheduling of the second OS 130, and determines whether or not the task which was placed into a running state is the first OS task 160 and whether or not there is a request to start an interruption processing task 500. When both of these conditions are fulfilled, the process goes to step S1303, whereas when at least one of the conditions is not fulfilled, the process returns to the program. Then, the CPU 111 executes the task which was placed into a running state as a result of the task scheduling of the second OS 130.

In step S1303, the CPU 111 executes a dispatch process by the first OS task 160. As a result, the interruption processing task 500 is dispatched. In step S1304, the CPU 111 prohibits all the interrupts of the debug target multi-task system 150 and executes the interruption processing task 500.

Next, a process for terminating the interruption processing task 500 will be described. FIG. 17 is a flowchart illustrating an example of a process of terminating the interruption processing task 500.

First in step S1401, the CPU 111 removes the interruption processing task 500 from the ready queue of the first OS task 160 and transfers the interruption processing task 500 to a dormant state. Next in step S1402, the CPU 111 executes a dispatch process by the first OS task 160. In order to permit or prohibit an interrupt of the task debug target multi-task system 150 in accordance with the interrupt state of a task which was placed into a running state by the dispatch process, in step S1403, the CPU 111 executes an interrupt permission/prohibition setting process of the debug target multi-task system 150. The CPU 111 then executes the task which was placed into a running state.

As described above, the interrupt process 500 is managed by the first OS task 160 as one task, and the interruption processing task 500 is executed with priority over the tasks of the debug target multi-task system 150 (the tasks 151 and 152) by the virtual interrupt control program 510. Since the priority levels can be set, the interruption processing task 500 can be executed with priority.

Next, a process of suspending the tasks of the debug target multi-task system (the tasks 151 and 152) and the interruption processing task 500 will be described.

The process of suspending a tasks of the debug target multi-task system 150 (the task 151 or 152) is executed at the time when an arbitrary task included in the multi-task system 150 (the task 151 or 152) reaches the break point, or when an exception occurs, like in the first embodiment. At this point, the CPU 111 suspends the execution of the first OS task 160.

The interrupt process 500 of the debug target multi-task system 150 is also managed by the first OS task 160. Therefore, the execution of the first OS task 160 is suspended at the time when the break point is reached or when an exception occurs as in the case of a general task (the task 151 or 152). Thus, the execution of the debug target multi-task system 150 is suspended.

Next, an exemplary operation of the virtual interrupt process according to this embodiment will be described. In this example, the task 141 is being executed and the interruption processing task 500 has not been started. The priority levels of the tasks managed by the second OS 130 are:
the task 141 (priority level 2)>the task 142 (priority level 3)>the first OS task 160 (priority level 4).

The priority levels of the tasks managed by the first OS task 160 are:
the interruption processing task 500 (priority level 1)>the task 151 (priority level 2)>the task 152 (priority level 3).

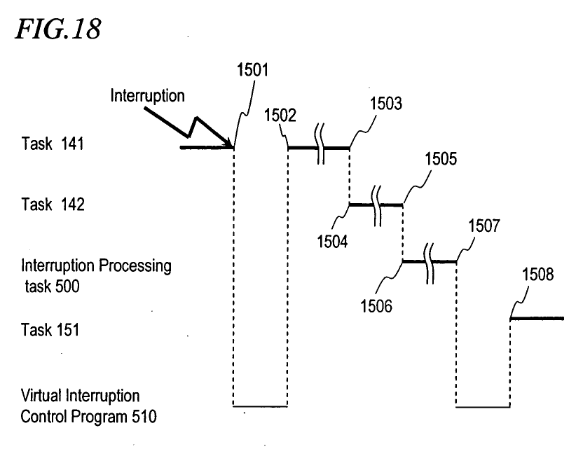

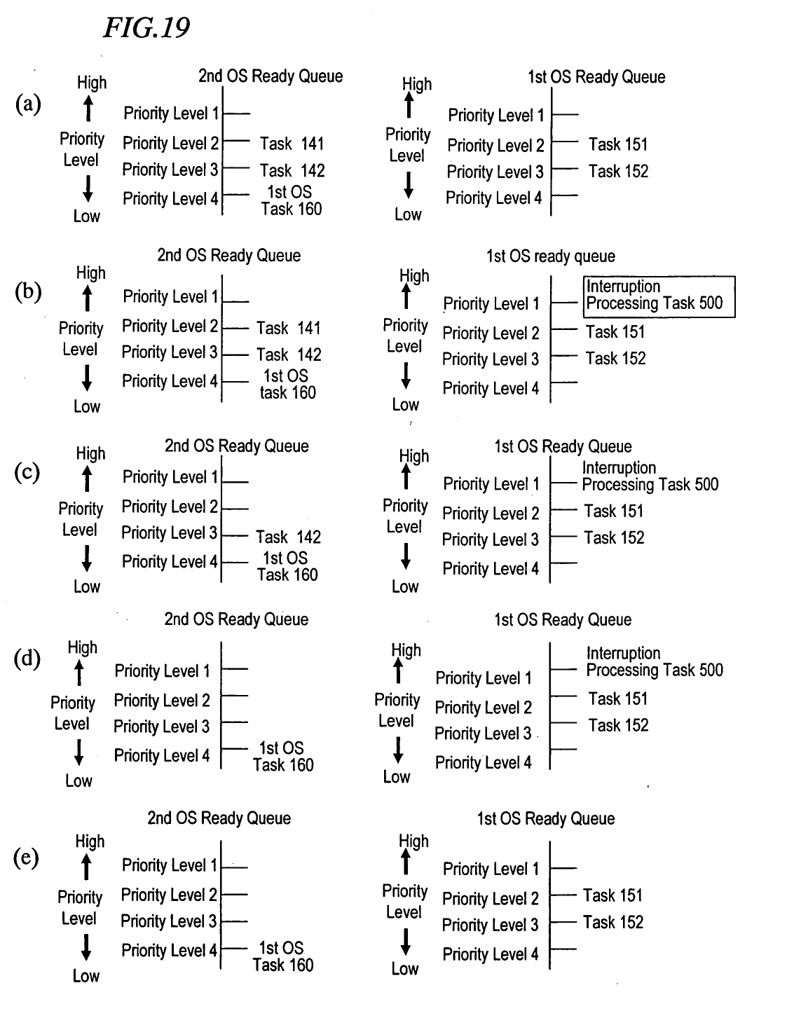

FIG. 18 shows timing of task transfer when an interrupt of the debug target multi-task system 150 occurs. FIG. 19 shows the states of the ready queues of the first OS task 160 and the second OS 130 in processes of starting and terminating the interruption processing task 500.

An operation of the virtual interrupt process when an interrupt of the debug target multi-task system 150 occurs will be described.

When an interrupt of the debug target multi-task system 150 occurs (1501 in FIG. 18, portion (a) of FIG. 19), the CPU 111 switches the control to an interrupt determining process of the virtual interrupt control program 510. Then, the CPU 111 executes a pre-process including the saving of the registers and the switching of the stacks (step S601 in FIG. 9). Next, the CPU 111 determines whether or not the interrupt is an interrupt of the debug target multi-task system 150 (step S602). Since the interrupt is an interrupt of the debug target multi-task system 150 in this example, the CPU 111 executes a process of starting the interruption processing task 500 (step S605).

Next, the CPU 111 issues a system call to the first OS task 160 for starting the interruption processing task 500 (step S1201 in FIG. 15, portion (b) of FIG. 19). Then, the CPU 111 checks whether or not the first OS task 160 is being executed (step S1202). Since the first OS task 160 is not being executed in this example, the CPU 111 sets a request to start the interruption processing task 500 in order to dispatch the interruption processing task 500 after the first OS task 160 is dispatched (step S1205). Then, the CPU 111 executes a post-process including the restoration of the registers, then returns from the interrupt, and executes the task 141 (1502 in FIG. 18). When the task 141 is finished (1503 in FIG. 18), a dispatch process by the second OS 130 is executed as follows.

First, the CPU 111 executes task scheduling of the second OS 130 (step S1301 in FIG. 16). As a result, the task 142 is placed into a running state (portion (c) of FIG. 19). The CPU 111 determines whether or not the task in the running state is the first OS task 160 and whether or not there is a request to start the interruption processing task 500 (step S1302). Since the task in the running state is not the first OS task 160 in this example, the task 142, which was placed into a running state, is executed (1504 in FIG. 18). When the task 142 is finished (1505 in FIG. 18), a dispatch process by the second OS 130 is executed. The CPU 111 executes the task scheduling of the second OS 130 (step S1301), as a result of which the first OS task 160 is placed into a running state (portion (d) of FIG. 19). The CPU 111 determines whether or not the task in the running state is the first OS task 160 and whether or not there is a request to start the interruption processing task 500 (step S1302). Since the task in the running state is the first OS task 160 and there is a request to start the interruption processing task 500 in this example, the CPU 111 executes a dispatch process by the first OS task 160 (step S1303). As a result, the interruption processing task 500 is dispatched. The CPU 111 prohibits all the interrupts of the debug target multi-task system 150 (step S1304) and executes the interruption processing task 500 (1506 in FIG. 18).

When the interruption processing task 500 is finished (1507 in FIG. 18), the CPU 111 removes the interruption processing task 500 from the ready queue of the first OS task 160 and transfers the interruption processing task 500 to a dormant state (step S1401 in FIG. 17, portion (e) of FIG. 19). Next, the CPU 111 executes a dispatch process by the first OS task 160 (step S1402), as a result of which the task 151 is placed into a running state. The CPU 111 sets the interrupts of the debug target multi-task system 150 to an interrupt permitted state or an interrupt prohibited state in accordance with the interrupt state of the task 151 (step S1403), and executes the task 151, which has been in a running state (1508 in FIG. 18). In this manner, the same effects as those provided by the debug system in the second embodiment are provided.

As described above, the debug target multi-task system 150 is managed by the first OS task 160. At the time when an arbitrary task included in the debug target multi-task system 150 (the task 151 or 152) reaches the break point, or when an exception occurs, the execution of the first OS task 160 is suspended. As a result, the execution of all the tasks included in the debug target multi-task system 150 (the tasks 151 and 152) can be suppressed while the environment for executing the tasks is retained. Even when, while the execution of the debug target multi-task system 150 is at a pause, a system call for changing the state of the tasks is issued to the second OS 130 by, for example, another task currently executed, such a system call does not influence the task 151 or 152 of the debug target multi-task system 150 managed by the first OS task 160. This facilitates debug of the multi-task systems.

The interrupt process by the debug target multi-task system 150 is managed by the first OS task 160 by the virtual interrupt process of performing an operation equivalent to the interrupt process. At the time when the break point is reached, or when an exception occurs, the execution of the first OS task 160 is suspended. As a result, the execution of all the tasks included in the debug target multi-task system 150 (the tasks 151 and 152) and the interrupt process 500 can be suppressed while the environment for executing the tasks is retained. This makes it possible to debug the entire multi-task system including the interrupt process 500, and thus debug is facilitated.

In this embodiment, the target system 110 includes two multi-task systems 140 and 150. The present invention is applicable to the case where the target system 110 includes three or more multi-task systems. In this embodiment, each multi-task system 140, 150 includes two tasks. The present invention is applicable to the case where one of, or both of, the multi-task systems 140 and 150 include three or more tasks. In this embodiment, the debug target multi-task system 150 has one interrupt process. The present invention is applicable to the case where the debug target multi-task system 150 has two or more interrupt processes.

In this embodiment, the non-debug target multi-task system 140 is managed by the second OS task 130. Alternatively, the multi-task system 140 may be managed by an OS task which is managed by the second OS 130. Even in the case where there are two or more non-debug target multi-task systems, each such multi-task system may be managed by an OS task, and these OS tasks may be managed by the second OS 130.

In this embodiment, in the process of prohibiting an interrupt in the process of starting the interruption processing task 500 (step S1204 in FIG. 15), in the process of prohibiting an interrupt in the dispatch process by the second OS 130 (step S1304 in FIG. 16), and in the process of permitting/prohibiting an interrupt in the process of terminating the interruption processing task 500 (S1403 in FIG. 17), all the interrupts of the debug target multi-task system 150 are permitted or prohibited. Alternatively, all the interrupts of the debug target multi-task system 150 and the multi-task system 140 may be permitted or prohibited.

According to the present invention, a method and a system useful for debugging a program for executing, in parallel, a plurality of multi-task systems including a plurality of tasks and an interrupt process are provided. With the program debug method and system of a multi-task system according to the present invention, when an arbitrary task and an interrupt process included in a debug target multi-task system reach a break point, or when an exception occurs, the execution of all the tasks and the interrupt process included in the debug target multi-task system is suppressed while an environment for executing the tasks and process is retained. Even when, while the debug target multi-task system is at a pause, another task which is being executed issues a system call for changing the state of the tasks, the tasks in the debug target multi-task system are not influenced by such a system call. Thus, debug of the multi-task systems is facilitated.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2004-258675 filed on Sep. 6, 2004 and No. 2005-254017 filed on Sep. 1, 2005, the entire contents of which are hereby incorporated by reference.

What is claimed is:

1. A debug system, comprising:
a host computer for executing a debugger program; and
a circuit having a complex system constructed thereon including a first multi-task system to be debugged by the debugger program and a second multi-task system which is not a target of debug;
wherein the circuit includes a memory having a program stored thereon and a processor capable of executing the program on the memory, and
wherein the memory has:
a first operating system for managing at least one task program included in the first multi-task system; and
a second operating system for managing the first operating system as a first task program and managing at least one second task program different from the first task program.

2. The debug system of claim 1, wherein:
the memory further has a monitor program for controlling execution of the first multi-task system; and
the processor executes the monitor program in response to a command from the host computer which has executed the debugger program, executes a process corresponding to the command, and returns a response to the host computer.

3. The debug system of claim 1, wherein the memory has the second operating system and the at least one second task program as the second multi-task system stored thereon.

4. The debug system of claim 1, wherein:
the memory has a third operating system and a third task program managed by the third operating system stored thereon as the at least one second task program; and
the memory stores the third operating system and the third task program as the second multi-task system.

5. The debug system of claim 2, wherein:
the circuit further has a stack; and
the processor saves an environment for executing the first multi-task system in the stack, and then suspends execution of the at least one task program included in the first multi-task system based on the monitor program.

6. The debug system of claim 5, wherein the processor suspends the execution of the first operating system when suspending the execution of the at least one task program included in the first multi-task system.

7. The debug system of claim 6, wherein when the process reaches a preset break point, the processor suspends the execution of the first operating system and suspends the execution of the at least one task program included in the multi-task system.

8. The debug system of claim 6, wherein when an exception occurs in the process, the processor suspends the execution of the first operating system and suspends the execution of the at least one task program included in the multi-task system.

9. The debug system of claim 1, wherein the processor is capable of executing an interrupt process of the first multi-task system on the first operating system, and executes the interrupt process of the first multi-task system with priority over any of the at least task program included in the first multi-task system.

10. The debug system of claim 1, wherein the processor is capable of executing an interrupt process of the first multi-task system on the first operating system, and executes the interrupt process of the first multi-task system with priority over any task program included in the complex system.

11. The debug system of claim 9, wherein the first operating system executed by the processor manages the interrupt process as an interrupt task program, and the processor executes the interrupt task program with priority over any of the at least one task program included in the first multi-task system.

12. The debug system of claim 10, wherein the first operating system executed by the processor manages the interrupt process as an interrupt task program, and the processor executes the interrupt task program with priority over any task program included in the complex system.

13. A circuit connected to a host computer for executing a debugger program and has a complex system constructed thereon including a first multi-task system to be debugged by the debugger program and a second multi-task system which is not a target of debug, the circuit comprising:
a memory having a program stored thereon; and
a processor capable of executing the program on the memory;
wherein the memory has:
a first operating system for managing at least one task program included in the first multi-task system; and
a second operating system for managing the first operating system as a first task program and managing at least one second task program different from the first task program.

14. A circuit connected to a host computer for executing a debugger program and being capable of having a complex system constructed thereon including a first multi-task system to be debugged by the debugger program and a second multi-task system which is not a target of debug, the circuit comprising:
a memory having a program stored thereon; and
a processor capable of executing the program on the memory;
wherein:
the memory has:
a first operating system; and
a second operating system for managing the first operating system as a first task program and managing at least one second task program different from the first task program; and
when at least one task program is read into the memory, the first operating system manages the at least one task program as a task program of the first multi-task system.
